(19) United States
(12) Patent Application Publication
(10) Pub. No.: US 2014/0351320 A1
(43) Pub. Date: Nov. 27, 2014

(54) METHOD, SYSTEM AND APPARATUS FOR COORDINATED PROCESSING OF DOCUMENT

(71) Applicants: Peking University Founder Group Co., Ltd., Beijing (CN); Peking University, Beijing (CN); Beijing Founder Apabi Technology Ltd., Beijing (CN)

(72) Inventors: Fei GAO, Beijing (CN); Li LIU, Beijing (CN); Xiaoyu CUI, Beijing (CN); Zhi TANG, Beijing (CN)

(73) Assignees: Peking University Founder Group Co., Ltd., Beijing (CN); Peking University, Beijing (CN); Beijing Founder Apabi Technology Ltd., Beijing (CN)

(21) Appl. No.: 14/092,669

(22) Filed: Nov. 27, 2013

(30) Foreign Application Priority Data
May 21, 2013 (CN) 201310190330.7

(51) Int. Cl. H04L 29/06

(52) U.S. Cl. CPC H04L 67/42
USPC 709/203

(57) ABSTRACT

Embodiments of the invention disclose a method, system and apparatus for coordinated processing of a document, relate to the field of data processing and are intended to address the problem of how multiple clients perform coordinated operations on the document. In the invention, a server detects a document operation on a first client among respective clients at a preset frequency and sends a detection result to a second client other than the first client; and the second client displays the detection result. Apparently this solution addresses the problem of how the multiple clients perform coordinated operations on the document.

This application claims the benefit of China Patent Application No. 201310190330.7, filed on May 21, 2013, which is incorporated herein by reference.

### FIELD OF THE INVENTION

The present invention relates to the field of data processing and particularly to a method, system and apparatus for coordinated processing of a document.

### BACKGROUND OF THE INVENTION

How to perform coordinated operations between multiple persons and between multiple documents currently has become a problem highly desirable to be addressed but also a bottleneck and a difficult issue to address, and it is necessary to perform other operations on the same active document in a multiple-party conference, during a panel discussion, for different demands of some attendees (e.g., those poorly sighted, aged, giving numerous comments, etc.) or due to some other reason.

In the course of a meeting at present, typically a lecturer prepares a PPT, delivers a lecture, controls the speed, etc., but listeners can not perform personalized adjusting to a font size, a display progression, etc., and can not make timely annotations, marks, etc., either upon occurrence of some question, but instead typically pass a notepaper with the question to the lecturer or raise their hands for presentation after the meeting.

If the attendees carry handheld devices, e.g., IPADs, smart mobile phones, etc., with themselves, then they may require the PPT and other materials of the lecturer to synchronized instantly onto their own handheld devices and thus can zoom in or out a display interface conveniently but also browse forward and backward, highlight some page, make annotations and marks, feed back comments, etc., conveniently.

For coordinated operations on the same document, e.g., a Word document, it is typical at present to use checkout and checkin functions of SharePoint so that a document in a checkout status can not be edited, modified, etc., by another user, but the another user will perform a corresponding operation only if the document is checked in, that is, the document can only be processed by a single user at a moment.

### SUMMARY OF THE INVENTION

Embodiments of the invention provide a method, system and apparatus for coordinated processing of a document so as to address the problem of how multiple clients perform coordinated operations on the document.

A method of coordinated processing of a document includes:

a server detecting a document operation on a first client among respective clients at a preset frequency; and

the server sending a detection result to a second client other than the first client.

A method of coordinated processing of a document includes:

a client receiving a detection result, sent from a server, of detecting a document operation on another client; and

the client displaying the received detection result.

A system for coordinated processing of a document includes:

a server configured to detect a document operation on a first client among multiple clients at a preset frequency and to send a detection result to second clients other than the first client; and

the multiple clients configured to display the detection result upon reception of the detection result sent from the server.

A server includes:

a detecting module configured to detect a document operation on a first client among respective clients at a preset frequency; and

a distributing module configured to send a detection result to a second client other than the first client.

A client includes:

In the solution according to the embodiments of the invention, a server detects a document operation on a first client among respective clients at a preset frequency and sends a detection result to a second client other than the first client; and the second client displays the received detection result. As can be apparent, in this solution, the server detects a document operation on the client and sends a detection result to the another client, and the another client displays the received detection result, so that the a user of the another client can perform a synchronization operation in response to the displayed information for the purpose of synchronous updating of the contents of the document on the multiple clients, that is, after the contents of the document on one of the clients are operated for update, the contents of the document on the another client can also be updated in synchronization, thereby addressing the problem of how the multiple clients perform coordinated operations on the document.

### BRIEF DESCRIPTION OF THE DRAWINGS

FIG. 1A is a schematic flow chart of a method according to an embodiment of the invention;

FIG. 1B is a schematic flow chart of another method according to an embodiment of the invention;

FIG. 1C is a schematic flow chart of a further method according to an embodiment of the invention;

FIG. 2A is a schematic flow chart of a first embodiment of the invention;

FIG. 2B is a schematic flow chart of a second embodiment of the invention;

FIG. 2C is a schematic flow chart of a third embodiment of the invention;

FIG. 3 is a schematic structural diagram of a system according to an embodiment of the invention;

FIG. 4 is a schematic structural diagram of a server according to an embodiment of the invention; and

FIG. 5 is a schematic structural diagram of a client according to an embodiment of the invention.

### DETAILED DESCRIPTION OF THE EMBODIMENTS

Embodiments of the invention provide a method of coordinated processing of a document so as to address the problem of how multiple clients perform coordinated operations on the document.

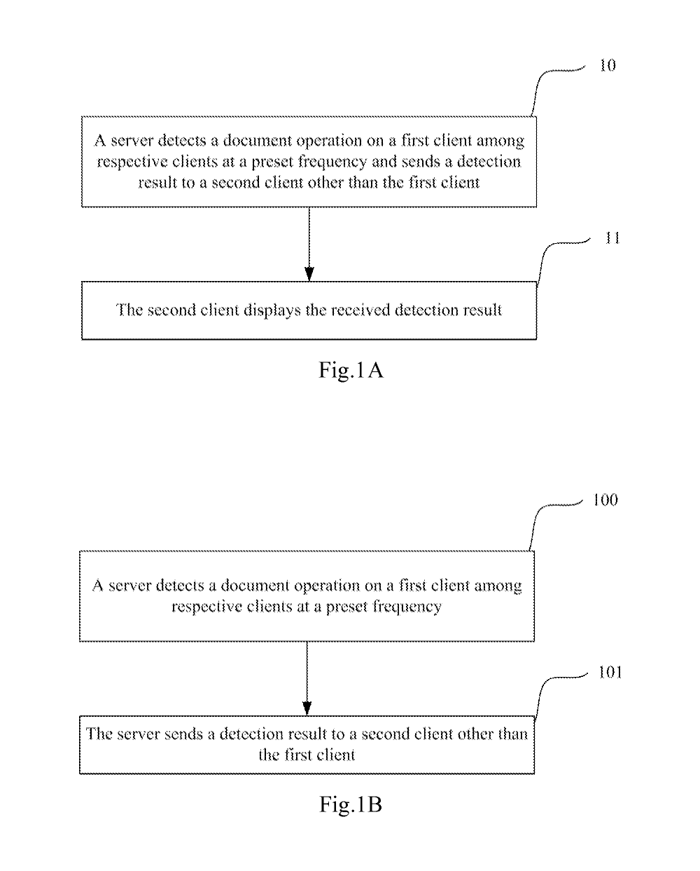

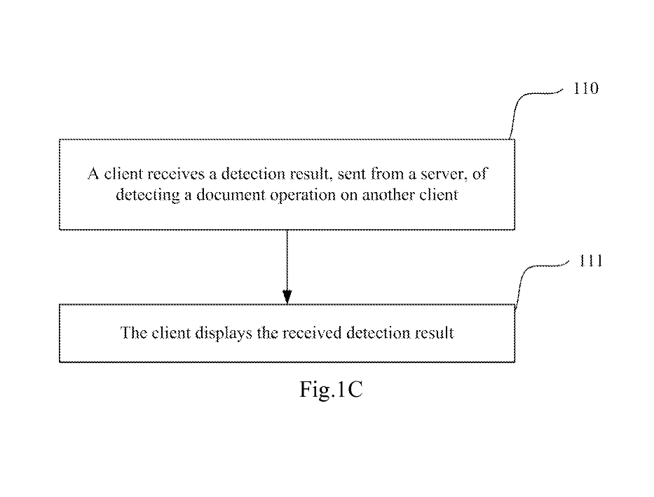

Referring to FIG. 1A, a method of coordinated processing of a document according to an embodiment of the invention includes the following steps:

Step 10: A server detects a document operation on a first client among respective clients at a preset frequency and sends a detection result to a second client other than the first client; and

Step 11: The second client displays the received detection result.

In the step 10, the server can monitor a document operation on the first client among the respective clients at the preset frequency and send a detection result to the second client other than the first client particularly as follows: the server detects statuses of the respective clients at the preset frequency, and the first client sends an update content and the location identifier of a document page where the update content is located to the server after a user performs an update operation on the document; and the server sends the received update content and location identifier to the second client other than the first client, where the types of operations to be detected include zooming-in or -out of a display interface, browsing-forward or -backward out of synchronization with a lecturer, etc., in addition to mark, annotation and other update operations.

Correspondingly the second client can update the document according to the received detection result in the step 11 particularly as follows: the second client displays the received update content and location identifier.

Preferably before the server detects a document operation on the first client among the respective clients at the preset frequency, the server receives a logon request, sent from each of the clients, carrying identity information of the client; and the server verifies the identity of the client according to the identity information of the corresponding client in the received logon request, and after verification is passed, the server allocates a document operation privilege for the client according to the identity information of the client and returns a logon response carrying the document operation privilege to the client; and the client performs privilege control on a user operation of the document according to the document operation privilege.

Preferably in the step 11, the server can firstly determine whether the second client is located in a local area network where the server is located, and if so, then the server can send the detection result to the second client in real-time; otherwise, the server can send the detection result to the second client after a preset delay, for example, the server can send the detection result to the second client after a delay of one minute.

Furthermore after a user performs an update operation on the document, the second client can determine whether to synchronize an update content to the another client according to attribute setting by the user, and if so, then the second client can send the update content and the location identifier of a document page where the update content is located to the server; and

The server sends a content presentation request to another client other than the second client; the another client determines whether to accept the content presentation request according to attribute setting by the user upon reception of the content presentation request and returns a determination result to the server; the server sends the received update content and location identifier of the document page where the update content is located from the second client to the another client upon determining from the returned result that the another client accepts the content presentation request; and the another client updates the document according to the received information.

Furthermore the server sends an indicator of a modification to a part of the contents of the document on a client to another client upon detection of the modification to the part of the contents, and the another client prohibits the user from modifying the same part of the contents of the document upon reception of the indicator; and the server associates a modification content with identifier information of a client upon detection of a modification to the contents of the document on the client; and generates and stores a document version after the client stores the modified document or at an interval of time and associates the document version with the identifier information of the client.

Furthermore the server can merge stored document versions and store a document into which they are merged, particularly as follows:

The server can merge stored document versions of a master client; or

The server can merge document versions of a client sending a document merging request; or

The server can merge document versions of the respective clients.

Here the server can merge the document versions by merging all or a part of modification contents in the document versions and particularly can select the modification contents to be merged according to an attribute(s) which is set by the user(s) on the modification contents in the document versions and/or the types of the modification contents. For example, only the modification contents for which a public attribute is set are merged, only the modification contents of the type of annotation are merged, etc.

Referring to FIG. 1B, another method of coordinated processing of a document according to an embodiment of the invention includes the following steps:

Step 100: A server detects a document operation on a first client among respective clients at a preset frequency and; and

Step 101: The server sends a detection result to a second client other than the first client.

Particularly the step 100 to the step 101 can be performed particularly as follows:

The server detects statuses of the respective clients at the preset frequency, and the first client sends an update content and the location identifier of a document page where the update content is located to the server after a user performs an update operation on the document; and the server sends the received update content and location identifier to the second client other than the first client.

Preferably before the server detects a document operation on the first client among the respective clients at the preset frequency, the server receives a logon request, sent from each of the clients, carrying identity information of the client; and the server verifies the identity of the client according to the identity information of the corresponding client in the received logon request, and after verification is passed, the server allocates a document operation privilege for the client according to the identity information of the client and returns a logon response carrying the document operation privilege to the client.

Preferably in the step 101, the server can send the detection result to the second client other than the first client particularly as follows: the server determines whether the second client is located in a local area network where the server is located, and if so, then the server can send the detection result to the second client in real-time; otherwise, the server can send the detection result to the second client after a preset delay.

Furthermore the server receives an update content and the location identifier of a document page where the update content is located, sent from the second client and sends a content presentation request to another client other than the second client; and the server sends the received update content and location identifier of the document page where the update content is located from the second client to the another client upon determining from a returned result of the another client that the another client accepts the content presentation request.

Furthermore the server sends an indicator of a modification to a part of the contents of the document on a client to another client upon detection of the modification to the part of the contents so that the another client prohibits a user from modifying the same part of the contents of the document; and the server associates a modification content with identifier information of a client upon detection of a modification to the contents of the document on the client; and generates and stores a document version after the client stores the modified document or at an interval of time and associates the document version with the identifier information of the client.

Furthermore the server can merge stored document versions and store a document into which they are merged. Here the server can merge the stored document versions particularly as follows:

The server can merge stored document versions of a master client; or the server can merge document versions of a client sending a document merging request; or the server can merge document versions of the respective clients.

Particularly the server can merge the document versions by selecting the modification contents to be merged according to an attribute(s) which is set by the user(s) on the modification contents in the document versions and/or the types of the modification contents.

Referring to FIG. 1C, a further method of coordinated processing of a document according to an embodiment of the invention includes the following steps:

Step 110: A client receives a detection result, sent from a server, of detecting a document operation on another client; and

Step 111: The client displays the received detection result.

Particularly the detection result received by the client can include an update content of a document update operation on the another client and the location identifier of a document page where the update content is located; and correspondingly the client displays the received detection result in the step S111 particularly as follows: the client displays the received update content and location identifier.

Furthermore the client sends an update content and the location identifier of a document page where the update content is located to the server after a user performs an update operation on the document.

Preferably before the client receives the detection result, the client can send a logon request carrying identity information of the client to the server; receive a logon response, returned from the server, carrying a document operation privilege; and perform privilege control on a user operation of the document according to the document operation privilege.

Furthermore after the user performs the update operation on the document, the client can determine whether to synchronize the update content to another client according to attribute setting by the user, and if so, then the client sends the update content and the location identifier of the document page where the update content is located to the server.

Furthermore the client receives a content presentation request sent from the server; determines whether to accept the content presentation request according to attribute setting by the user and returns a determination result to the server; and receives the update content of the another client and the location identifier of the document page where the update content is located, sent from the server and displays the received information.

Furthermore the client receives an indicator of a modification to a part of the contents of the document on the another client, sent from the sever and prohibits the user from modifying the same part of the contents of the document in response to the indicator.

The invention will be described below in connection with particular embodiments.

### First Embodiment

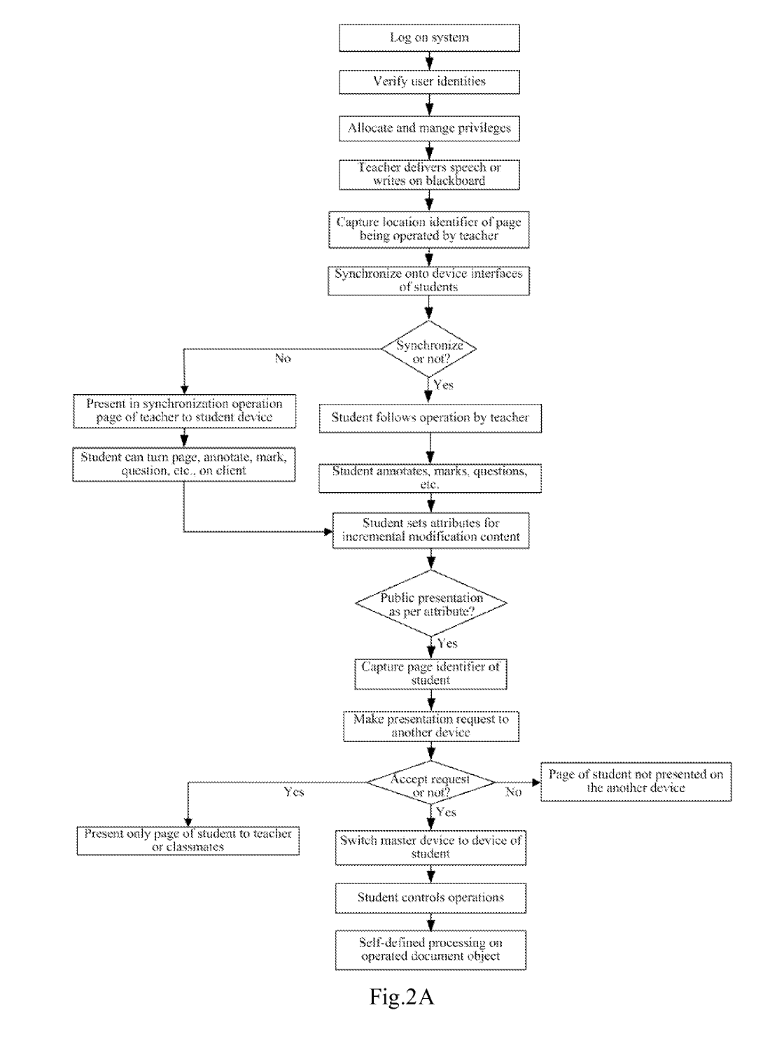

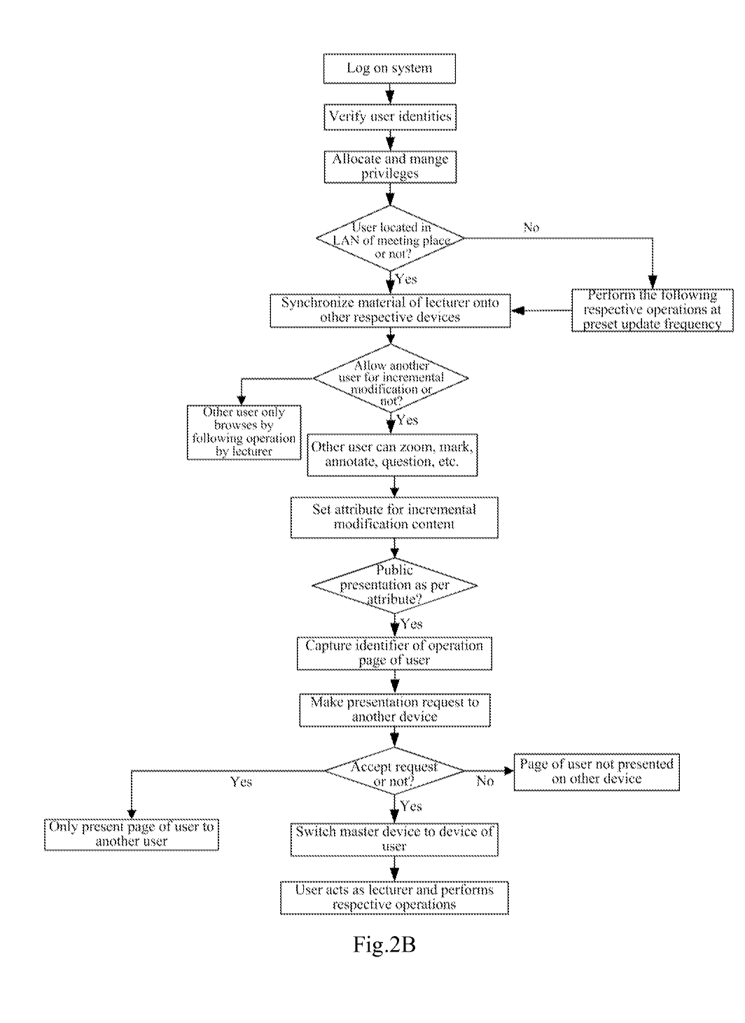

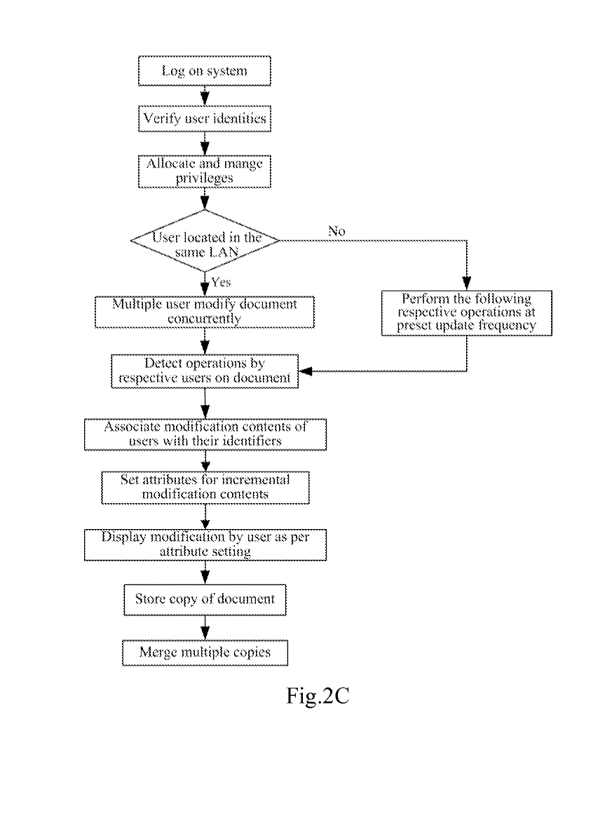

As illustrated in FIG. 2A, an implementation flow is as follows:

Step 1: Clients where a teacher and students are located log on a server;

Step 2: A privilege control and management module of the server authenticates the identities of the respective clients and allocate privileges for the clients passing authentication, where the client where the client where the teacher is located is defaulted as a master;

Step 3: The teacher can perform various operations on a screen of his or her client, for example, writing on a blackboard, marking exercises, etc.;

Step 4: A detecting module of the server detects an operation by the teacher at a preset detection frequency;

Step 5: A detection result is synchronized in real-time onto screens of the clients where the respective clients are located;

In the step 4, the client where the teacher is located captures an update content made on a page by the teacher and the location identifier of the page where the update content is located and submits the data to the server; and then the server sends the data to the clients where the clients are located;

Step 6: After the server synchronizes the detection result onto the screen of the clients where the clients are located, the students set on the clients whether to only follow the operation by the teacher or perform another operation together with synchronization with the operation by the teacher;

Step 7: When a students sets only following the operation by the teacher, he or she still can make notes, marks and other annotations on the page operated by the teacher or present problems in the form of annotations;

Step 8: The student sets on the client attributes for his or her own incremental modification content, for example, “Private” for only memos for his or her own later review, “Public” for possible presentation to the clients where the teacher and the other students are located, “Question” for presentation of questions to the client where the teacher is located, etc.;

Step 9: If the student sets the attribute of his or her own incremental modification content to “Public” or “Question”, then the client where the student is located sends a presentation request to the server, where the presentation request carries the incremental modification content made by the student and the location identifier of a page where the incremental modification content is located;

Step 10: A control data module of the server submits the presentation request of the student to the other clients in the system, and the teacher and the other students can process the presentation request on their own clients by selecting “Accept and Present Immediately”, “Accept and Present later”, “Reject”, etc., so that the teacher can choose to present a question of a student instantly or later together with a question of another student;

Step 11: The server will not synchronize the received incremental modification content onto another client if the another client selects “Reject”;

Step 12: If the another client selects “Accept and Present Immediately” or “Accept and Present later”, then there are two alternatives that only the received incremental modification content is presented to the another client or both the received incremental modification content is presented to the another client and the another client is switched to a master;

Step 13: Subsequent to the step 6, the students can further set both the operation page of the teacher and the operation by the teacher to be synchronized to their own clients while perform some operations on their own initiatives on the clients, for example, paging forward or backward to search for data, performing other marking, note-making, question raising and other incremental modification operations on a page different from that operated by the teacher, etc.;

Step 14: Subsequent to the step 13, the students can further set attributes for their own incremental modification contents, that is, perform the step 8 and the respective operations subsequent thereto.

Step 15: The server has operated documents merged by a document processing module in response to a document merging or storage demand of a user, where the merging or storage demand can include storage of only writing by the teacher on the blackboard, storage of only notes or marks of a client, storage of all the incremental modification contents, etc., dependent upon a practical demand of the user.

### Second Embodiment

As illustrated in FIG. 2B, an implementation flow is as follows:

Step 1. Respective clients log on a server;

Step 2. A privilege control and management module of the server performs identity verification with usernames or IDs in logon requests and allocates privileges for the clients passing verification;

Step 3: The server determines whether a client is located in a local area network of a meeting place, and if it is located in the a local area network, then synchronization and operations as described in the following respective steps can be performed in real-time; or if the client is not located in the local area network, for example, an important attendee fails to be present at the meeting due to illness or other special reasons, then the client still can perform the operations as described below after accessing the server except for a preset variable delay in update, presentation, etc., for example, a delay of one minutes;

Step 4: The server synchronizes a document material of a lecture onto the clients of respective users (attendees);

Step 5: Before a user performs an operation on the document material on a client, the client needs to check a privilege of the user and will allow the operation by the user on the document material only if a document operation privilege is available;

Step 6: A detecting module of the server detects document operation conditions on the respective clients at a preset interval of time;

Step 7: Another client can only browse the document material by following an operation by the lecturer only if the another client is not allowed for incremental modification;

Step 8: The another client can perform zooming, annotation, paging and browsing and other incremental modification operations on the presented document material as required by a user if the another client is allowed for incremental modification;

Step 9: A user can set an attribute as needed for an annotation, a mark or another incremental modification content, for example, private presentation or public presentation;

Step 10: The server makes subsequent determination according to the attribute setting of the user;

Step 11: If the attribute is set to public presentation, then the client passes the incremental modification content made by the user and the location identifier of a page where the incremental modification content is located to the server;

Step 12: If the attribute is set to public presentation, then also a control data module of the server needs to sent a presentation request to another client;

Step 13: When the another client accepts the presentation request, the server can synchronize the incremental modification content and the location identifier of the page where the incremental modification content is located onto the another client which in turn can update the document with the synchronization content; and

Step 14: When the another client accepts the presentation request, the master client can be switched, that is, the client of the lecture is replaced by the another client.

### Third Embodiment

As illustrated in FIG. 2C, an implementation flow is as follows:

Step 1. Clients log on a server;

Step 2. A privilege control and management module of the server authenticates the identifies of the respective clients and allocate privileges for the clients passing authentication;

Step 3. The server determines whether a client is located in the same local area network, where clients in a common office area are user members in the same local area network;

Step 4. If it is located in the same local area network, then synchronization and operations as described in the following respective steps can be performed in real-time; or if the client is not located in the same local area network, for example, an important attendee fails to be present at the meeting due to illness or other special reasons, then the client still can perform the operations as described below after accessing the server except for a preset variable delay in update, presentation, etc., for example, a delay of one minutes;

Step 5. The multiple clients modify a document concurrently, and at this time a detecting module in the server detect in real-time document operations on the respective clients;

Step 6. When a user A of a client modifies a part of the contents of the document, the server indicates to the other clients that the part of the contents is being modified by the user A and does not allow the other users for modifying the part of the contents while allowing another part of the document to be modified;

Step 7. The server associates an edition, an annotation or another incremental modification content made by the user A with the identifier of the user;

Step 8. When the user A stores the document modified by the user, the server generates a document version for the user by providing the version with a version number and associating the version with the user A;

Here the server can alternatively store the foregoing information automatically at an interval of time;

Step 9. A user B, a user C, etc., can also edit, annotate, etc., other parts of the document;

Step 10. Each user can set an attribute for his or her own edition, annotation or other information as Private, Public, Reference and Deleted for Finalization, etc;

Step 11. A document processing module of the server displays the public editions, annotations and other incremental modification contents on the other clients operating on the document concurrently;

Step 12. The document processing module of the server uniformly deletes the editions, annotations and other incremental modification contents for reference and deleted for finalization to finalize the document edited by the respective users; and

Step 13. The document processing module of the server finalizes the document at a user-set interval of time or in response to a finalization request from a leader of the group of users.

It shall be noted that the first embodiment, the second embodiment and the third embodiment are common in that the server can support management of multiple devices, that is, allocation and management of privileges of the multiple devices, joining or quitting of one or more devices, replacement of a master device, etc.

There are two differences between a master client and a normal client: when the server sends a presentation request of the master (master-privileged) client to another client, even if the another client selects “Reject”, then the server will present an update content of the master client to the another client but will allow the another client to perform another type of operation in another process or software; and when the server sends a presentation request of the normal client to another client, if the another client selects “Reject”, then the server will not synchronize an update content of the normal client to the another client for presentation.

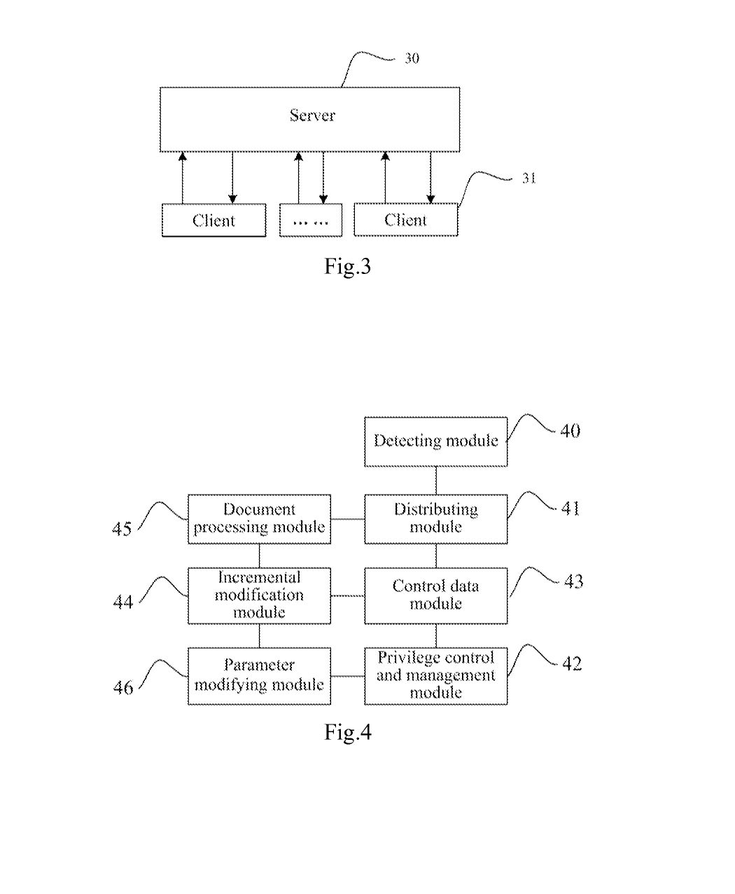

Referring to FIG. 3, a system for coordinated processing of a document according to an embodiment of the invention includes:

A server 30 is configured to detect a document operation on a first client among multiple clients at a preset frequency and to send a detection result to second clients other than the first client; and

The multiple clients 31 are configured to display the detection result upon reception of the detection result sent from the server.

Referring to FIG. 4, a server according to an embodiment of the invention includes:

A document processing module 45 is configured to store and maintain documents throughout a system and respective operation and processing procedures on the documents;

A detecting module 40 and a distributing module 41 are configured to obtain in real-time operation information of a user and to distribute the information to the other users;

An incremental modifying module 44 is configured to store respective incremental modification operations performed by the respective users on a document object and to associate the contents of the incremental modifications with the identifiers of the respective users;

A control data module 43 is configured to receive request, submission, storage and other control data passed from a client, including the location identifier of a display area of a device captured by the client, to pass the location identifier and send the control data to another device in response to a demand;

A parameter modifying module 46 is configured to manage generation, allocation, modification, obtainment, etc., of respective parameters in the system; and

A privilege control and management module 42 is configured to manage information about the user logging on the system and respective privileges available thereto, to manage effectively the respective privileges and to manage the multiple devices including allocation and management of privilege of the multiple devices and joining or quitting of one or more devices.

A particular description is given below:

A detecting module 40 is configured to detect a document operation on a first client among respective clients at a preset frequency; and

A distributing module 41 is configured to send a detection result to a second client other than the first client.

Furthermore the detecting module 40 is further configured:

To detect statuses of the respective clients at the preset frequency and to receive an update content and the location identifier of a document page where the update content is located, sent from the first client after a user performs an update operation on a document; and

The distributing module 41 is further configured to send the received update content and location identifier to the second client other than the first client.

Furthermore the server further includes:

A privilege control and management module 42 is configured to receive a logon request, sent from each of the clients, carrying identity information of the client; and to verify the identity of the client according to the identity information of the corresponding client in the received logon request, and after verification is passed, to allocate a document operation privilege for the client according to the identity information of the client and to return a logon response carrying the document operation privilege to the client; and

Furthermore the distributing module 41 is configured:

To determine whether the second client is located in a local area network where the server is located, and if so, to send the detection result to the second client in real-time; otherwise, to send the detection result to the second client after a preset delay.

Furthermore the server further includes:

A control data module 43 is configured to receive an update content and the location identifier of a document page where the update content is located, sent from the second client and to send a content presentation request to another client other than the second client; and to send the received update content and location identifier of the document page where the update content is located from the second client to the another client upon determining from a returned result of the another client that the another client accepts the content presentation request.

Furthermore the server further includes:

An incremental modifying module 44 is configured to send an indicator of a modification to a part of the contents of the document on a client to another client upon detection of the modification to the part of the contents so that the another client prohibits a user from modifying the same part of the contents of the document; and

To associate a modification content with identifier information of a client upon detection of a modification to the contents of the document on the client; and to generate and store a document version after the client stores the modified document or at an interval of time and to associate the document version with the identifier information of the client.

Furthermore the server further includes:

A document merging module 45 is configured to merge document versions and store a document into which they are merged.

Furthermore the document merging module 45 is further configured:

To merge stored document versions of a master client; or

To merge document versions of a client sending a document merging request; or

To merge document versions of the respective clients.

Furthermore the document merging module 45 is further configured:

To merge the document versions by selecting modification contents to be merged according to an attribute(s) which is set by the user(s) on the modification contents in the document versions and/or the types of the modification contents.

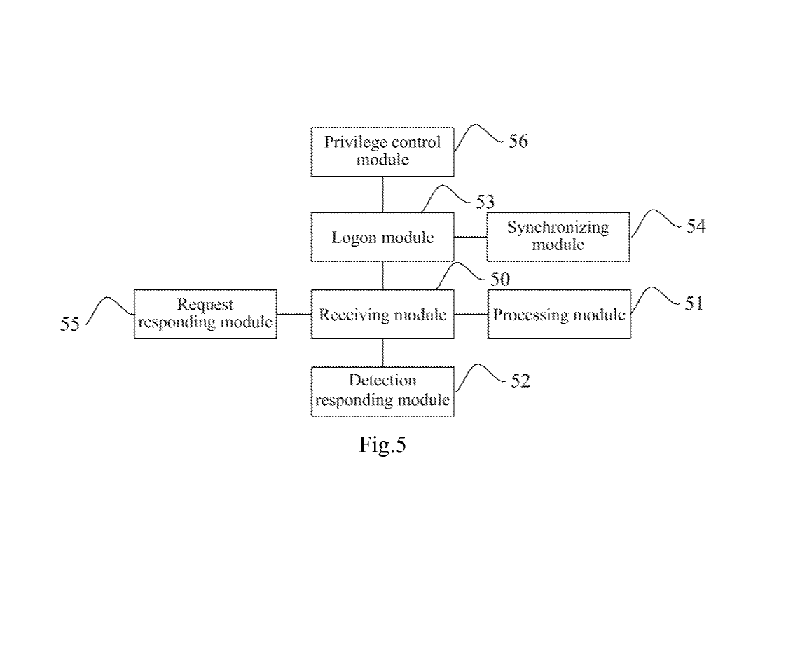

Referring to FIG. 5, an client according to an embodiment of the invention can be used for a user to perform various operations including document presentation, view adjusting, edition and other operations, the client being configured to capture on its own initiative the location identifier of a display area of a user equipment and send it to a server; and to receive control data passed from the server and perform a corresponding operation in response to the control data, particularly as follows:

The client includes:

A receiving module 50 is configured to receive a detection result, sent from a server, of detecting a document operation on another client; and

A processing module 51 is configured to display the received detection result.

Furthermore the processing module 51 is configured:

When the detection result includes an update content of a document update operation on the another client and the location identifier of a document page where the update content is located, to display the received content and the location identifier of the document page where the update content is located.

Furthermore the client further includes:

A detection responding module 52 is configured to send an update content and the location identifier of a document page where the update content is located to a server after a user performs an update operation on a document

Furthermore the client further includes:

A logon module 53 is configured to send a logon request carrying identity information of the client to the server; and

To receive a logon response, returned from the server, carrying a document operation privilege; and to perform privilege control on a user operation of the document according to the document operation privilege.

Furthermore the client further includes:

A synchronizing module 54 is configured, after the user performs the update operation on the document, to determine whether to synchronize the update content to another client according to attribute setting by the user, and if so, to send the update content and the location identifier of the document page where the update content is located to the server.

Furthermore the client further includes:

A request responding module 55 is configured to receive a content presentation request sent from the server; to determine whether to accept the content presentation request according to attribute setting by the user and return a determination result to the server; and to receive the update content of the another client and the location identifier of the document page where the update content is located, sent from the server and display the received information.

Furthermore the client further includes:

A privilege control module 56 is configured to receive an indicator of a modification to a part of the contents of the document on the another client, sent from the sever and to prohibit the user from modifying the same part of the contents of the document in response to the indicator.

In summary the invention has the following advantageous effects:

In the solution according to the embodiments of the invention, a server detects a document operation on a first client among respective clients at a preset frequency and sends a detection result to a second client other than the first client; and the second client displays the received detection result. As can be apparent, in this solution, the server detects a document operation on the client and sends a detection result to the another client, and the another client displays the received detection result, so that the a user of the another client can perform a synchronization operation in response to the displayed information for the purpose of synchronous updating of the contents of the document on the multiple clients, that is, after the contents of the document on one of the clients are operated for update, the contents of the document on the another client can also be updated in synchronization, thereby addressing the problem of how the multiple clients perform coordinated operations on the document.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. A method of coordinated processing of a document, comprising:
a server detecting a document operation on a first client among respective clients at a preset frequency; and
the server sending a detection result to a second client other than the first client.

2. The method according to claim 1, wherein the server detecting a document operation on the first client among the respective clients at the preset frequency and sending a detection result to the second client other than the first client further comprises:
the server detecting statuses of the respective clients at the preset frequency, and the first client sending an update content and a location identifier of a document page where the update content is located to the server after a user performs an update operation on the document; and the server sending the received update content and location identifier to the second client other than the first client.

3. The method according to claim 1, further comprising, before the server detecting a document operation on the first client among the respective clients at the preset frequency:
the server receiving a logon request, sent from a client, carrying identity information of the client; and
the server verifying identity of the client according to the identity information of the client in the received logon request, and after verification is passed, allocating a document operation privilege for the client according to the identity information of the client and returning a logon response carrying the document operation privilege to the client.

4. The method according to claim 1, wherein the sending a detection result to the second client other than the first client further comprises:
the server determining whether the second client is located in a local area network where the server is located, and if so, then sending the detection result to the second client in real-time; otherwise, sending the detection result to the second client after a preset delay.

5. The method according to claim 1, further comprising:
the server receiving an update content and a location identifier of a document page where the update content is located, sent from the second client, and sending a content presentation request to another client other than the second client; and sending the update content and location identifier of the document page, where the update content is located, received from the second client to the another client upon determining from a result returned from the another client that the another client accepts the content presentation request.

6. The method according to claim 1, further comprising:
the server sending an indicator of a modification to a part of the contents of the document on a client to another client upon detection of the modification to the part of the contents so that the another client prohibits a user from modifying the same part of the contents of the document; and
the server associating a modification content with identifier information of a client upon detection of a modification to the contents of the document on the client; and generating and storing a document version after the client stores the modified document or at an interval of time and associating the document version with the identifier information of the client.

7. The method according to claim 6, further comprising:
the server merging stored document versions and storing a document into which they are merged.

8. The method according to claim 7, wherein the server merging the stored document versions further comprises:
the server merging stored document versions of a master client; or
the server merging document versions of a client sending a document merging request; or
the server merging document versions of the respective clients.

9. The method according to claim 8, wherein the server merges the document versions by selecting the modification contents to be merged according to an attribute which is set by a user on the modification contents in the document versions and/or types of the modification contents.

10. A method of coordinated processing of a document, comprising:
a client receiving a detection result, sent from a server, of detecting a document operation on another client; and
the client displaying the received detection result.

11. The method according to claim 10, wherein the detection result received by the client includes an update content of a document update operation on the another client and the location identifier of a document page where the update content is located; and
the client displaying the received detection result i further comprises:
the client displaying the received update content and location identifier.

12. The method according to claim 11, further comprising:
the client sending an update content and the location identifier of a document page where the update content is located to the server after a user performs an update operation on the document.

13. The method according to claim 10, further comprising, before the client receives the detection result:
the client sending a logon request carrying identity information of the client to the server; receiving a logon response, returned from the server, carrying a document operation privilege; and performing privilege control on a user operation of the document according to the document operation privilege.

14. The method according to claim 10, further comprising:
after a user performs an update operation on the document, the client determining whether to synchronize an update content to another client according to attribute setting by the user, and if so, then sending the update content and the location identifier of a document page where the update content is located to the server.

15. The method according to claim 14, further comprising:
the client receiving a content presentation request sent from the server; determining whether to accept the content presentation request according to attribute setting by the user and returning a determination result to the server; and receiving the update content of the another client and the location identifier of the document page where the update content is located, sent from the server and displaying received information.

16. The method according to claim 10, further comprising:
the client receiving an indicator of a modification to a part of contents of a document on the another client, sent from the sever and prohibiting a user from modifying same part of the contents of the document in response to the indicator.

17. A system for coordinated processing of a document, comprising:
a server configured to detect a document operation on a first client among multiple clients at a preset frequency and to send a detection result to second clients other than the first client; and
the multiple clients configured to display the detection result upon reception of the detection result sent from the server.
